(19) United States
(12) Patent Application Publication
(10) Pub. No.: US 2021/0063553 A1
(43) Pub. Date: Mar. 4, 2021

(54) Measurement Method of Ultrasonic Wave Using Capacitive Micromachined Ultrasonic Transducer

(71) Applicant: Hitachi, Ltd., Tokyo (JP)

(72) Inventors: Taiichi TAKEZAKI, Tokyo (JP); Shuntaro MACHIDA, Tokyo (JP)

(21) Appl. No.: 17/007,237

(22) Filed: Aug. 31, 2020

(30) Foreign Application Priority Data
Sep. 2, 2019 (JP) 2019-159761

(51) Int. Cl. G01S 7/52

(52) U.S. Cl. CPC G01S 7/52085

(57) ABSTRACT

Disclosed is a measurement method of ultrasonic waves using a capacitive micromachined ultrasonic transducer. The method includes measuring a ultrasonic wave by applying a bias voltage to the capacitive micromachined ultrasonic transducer in each of a plurality of first periods, and applying a voltage that is equal to or greater than 0V and smaller than the bias voltage to the capacitive micromachined ultrasonic transducer in a second period between two first periods among the plurality of first periods.

### CLAIM OF PRIORITY

The present application claims priority from Japanese patent application JP2019-159761 filed on Sep. 2, 2019, the content of which is hereby incorporated by reference into this application.

### BACKGROUND

The present invention relates to a measurement method of an ultrasonic wave using a capacitive micromachined ultrasonic transducer.

Conventionally, piezoelectric ceramics such as PZT (lead zirconate titanate) have been used as an electroacoustic exchange element for a probe of an ultrasonic imaging apparatus. WO2006/109501 discloses a testing method for piezoelectric elements.

In recent years, a CMUT (capacitive micromachined ultrasonic transducer) having a wider band property than that of piezoelectric ceramics is drawing attention and the research and development of CMUT has been underway. A capacitive micromachined ultrasonic transducer has a hollow portion covered by an insulating film in a semiconductor substrate. A lower electrode is disposed under the hollow portion, and a diaphragm including an upper electrode is disposed above the hollow portion.

The capacitive micromachined ultrasonic transducer applies a voltage between the lower electrode and the upper electrode to make a potential difference, thereby generating an electrostatic force in the diaphragm above the hollow portion. In transmitting ultrasonic waves, the capacitive micromachined ultrasonic transducer vibrates the diaphragm by applying a DC bias voltage superimposed with an AC voltage and changing the electrostatic force acted on the diaphragm over time. In receiving ultrasonic waves, a displacement of the diaphragm, caused by the applied DC bias voltage, is detected as a change in capacitance between the upper and lower electrodes.

### SUMMARY

The reception sensitivity can be improved by increasing the bias voltage on the capacitive micromachined ultrasonic transducer. However, if a high-level bias voltage is continuously applied for a long period of time, the reception sensitivity of the capacitive micromachined ultrasonic transducer would largely decrease. Thus, a technology to improve reliability while suppressing a decrease in reception sensitivity of capacitive micromachined ultrasonic transducers is sought after.

An aspect of the present invention is a measurement method of ultrasonic waves using a capacitive micromachined ultrasonic transducer, including: measuring a ultrasonic wave by applying a bias voltage to the capacitive micromachined ultrasonic transducer in each of a plurality of first periods; and applying a voltage that is equal to or greater than 0V and smaller than the bias voltage to the capacitive micromachined ultrasonic transducer in a second period between two first periods among the plurality of first periods. According to a representative embodiment, it is possible to suppress a decrease in reception sensitivity of capacitive micromachined ultrasonic transducers.

### BRIEF DESCRIPTION OF THE DRAWINGS

FIG. 1 is a perspective view showing an overall configuration of an ultrasonic imaging apparatus;

FIG. 2 is a block diagram showing a hardware configuration example of the ultrasonic imaging apparatus;

FIG. 3 schematically illustrates a cross-sectional structure of a basic CMUT;

FIG. 4 schematically illustrates a CMUT that receives an ultrasonic wave;

FIG. 5 illustrates the temporal change of the DC voltage applied to the CMUT;

FIG. 6 is a graph showing a change in reception sensitivity when the voltage applied to the CMUT is reduced intermittently, and a change in reception sensitivity when the DC bias voltage is continuously applied;

FIG. 7 shows an example of a temporal change of the DC voltage applied to the CMUT, and the period B coincides with the exchange of imaging samples;

FIG. 8 schematically illustrates a relationship between an ultrasonic image generated by the ultrasonic imaging apparatus, and the trajectory of the imaging position; and

FIG. 9 is a flowchart showing an example of the driving method for CMUT that depends on the sensitivity test result.

### DETAILED DESCRIPTION OF THE EMBODIMENTS

Embodiments of the present are described below with reference to the accompanying drawings. It should be noted that the embodiments are merely examples of how the present is carried out, and are not to limit the technical scope of the present. Duplicate descriptions are omitted if necessary for a clearer description.

### Embodiment 1

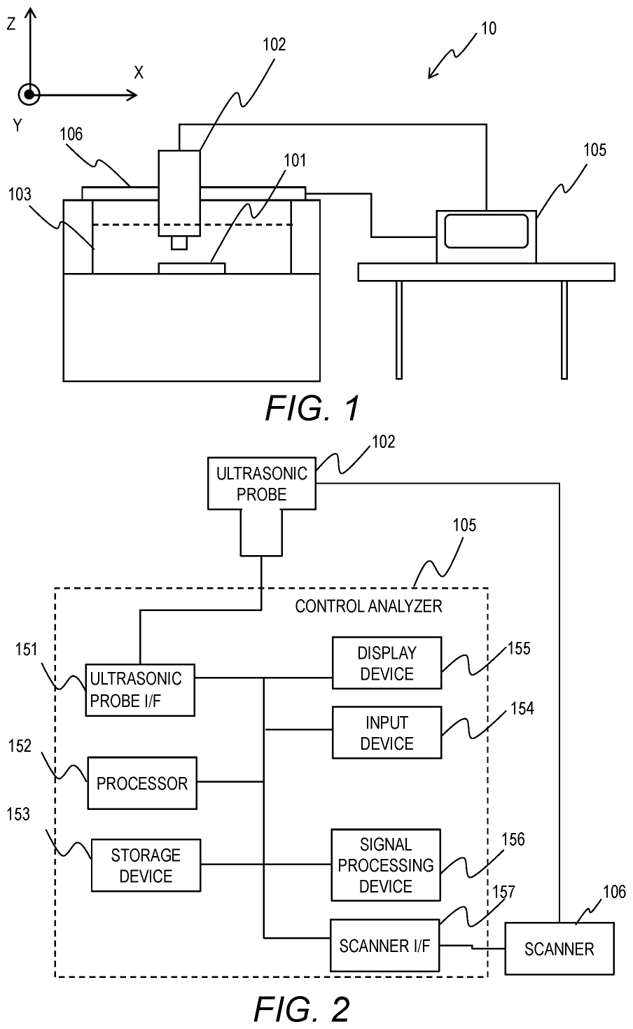

With reference to FIGS. 1 and 2, a configuration example of an ultrasonic imaging apparatus of this embodiment will be explained. FIG. 1 is a perspective view showing an overall configuration of an ultrasonic imaging apparatus. FIG. 2 is a block diagram showing a hardware configuration example of the ultrasonic imaging apparatus. In FIGS. 1 and 2, an ultrasonic testing apparatus is illustrated as an example of the ultrasonic imaging apparatus.

As illustrated in FIG. 1, an ultrasonic imaging apparatus 10 includes an imaging target 101, an ultrasonic probe 102, a water tank 103, a control analyzer 105, and a scanner 106. The imaging target 101 is placed in water in the water tank 103. The scanner 106 moves the ultrasonic probe 102 along the X axis and Y axis on the XY plane.

The ultrasonic probe 102 is a device that transmits and receives ultrasonic waves to and from the imaging target 101, and includes an ultrasonic transducer array made up of a number of ultrasonic transducers arranged two-dimensionally, an acoustic lens that converges ultrasonic waves from the ultrasonic transducer array, a backing member, and the like. The ultrasonic transducer of this embodiment is a CMUT (capacitive micromachined ultrasonic transducer).

The control analyzer 105 is an example of a controller, and is connected to the ultrasonic probe 102 and the scanner 106 so that they can communicate with each other, and the control analyzer 105 is configured to control the probe 102 and the scanner 106. Specifically, the control analyzer 105 controls the scanner 106 and moves the ultrasonic probe 102 in the directions along the X axis and Y axis to obtain an image of the imaging target 101. The control analyzer 105 drives the ultrasonic probe 102, and processes a signal (echo signal) received from the ultrasonic probe 102 that has received an ultrasonic wave, thereby generating an ultrasonic image of the imaging target 101.

FIG. 1 illustrates a reflective ultrasonic imaging apparatus as an example of the ultrasonic imaging apparatus. The ultrasonic probe 102 generates ultrasonic waves and transmits the ultrasonic waves to the imaging target 101, and receives ultrasonic waves reflected by the imaging target 101. The method of driving capacitive micromachined ultrasonic transducers of this embodiment can be applied to various types of ultrasonic imaging apparatus. For example, the driving method of this embodiment can be applied to a transmissive ultrasonic imaging apparatus. In a transmissive ultrasonic imaging apparatus, an ultrasonic probe does not transmit ultrasonic waves, but receives ultrasonic waves that were transmitted from another device and that have passed through the imaging target. The driving method of this embodiment can also be applied to an ultrasonic imaging apparatus that does not include a scanner that moves the ultrasonic probe 102 mechanically, an ultrasonic imaging apparatus configured to scan the imaging target by selecting an ultrasonic transducer to generate ultrasonic waves in sequence, and the like.

Also, the driving method of this embodiment can also be applied to a portable or mobile ultrasonic imaging apparatus, an ultrasonic diagnosis apparatus, and the like. As described above, the driving method of the present invention can be applied to any types of ultrasonic probes that use a capacitive micromachined ultrasonic transducer.

In FIG. 2, the control analyzer 105 includes an ultrasonic probe interface (I/F) 151, a processor 152, a storage device 153, an input device 154, a display device 155, a signal processing device 156, and a scanner interface (I/F) 157, which can communicate with each other through a bus.

As described above, the ultrasonic probe 102 transmits ultrasonic waves to the imaging target 101, and receives ultrasonic waves from the imaging target 101. The ultrasonic probe 102 transmits ultrasonic waves to the imaging target 101 through water. Echo from the imaging target 101 is received by the ultrasonic probe 102 through water. The ultrasonic probe 102 is electrically connected to the ultrasonic probe interface 151 for communication. The ultrasonic probe interface 151 includes a transmission/reception separating circuit, a transmission circuit, a DC bias circuit, a reception circuit, a delay circuit, a gain adjusting circuit, a filter circuit, an analog digital circuit, and the like.

In transmitting ultrasonic waves, the ultrasonic probe interface 151 transmits a driving signal (driving voltage) made of superimposed DC bias signal (DC bias voltage) and AC signal (AC voltage) to the ultrasonic probe 102. In receiving echo (ultrasonic waves) reflected by the imaging target 101, the ultrasonic probe interface 151 receives a measurement signal (echo signal) corresponding to the echo from the ultrasonic probe 102 while applying the DC bias signal to the ultrasonic probe 102. The ultrasonic probe interface 151 performs processes on the received echo signal such as delay, gain adjustment, filtering, analog-digital conversion, and the like. The signal processing device 156 is configured to perform processes necessary for correction and image generation such as LOG compression and depth correction on the received echo signal, and may include a DSC (digital scan converter), a color doppler circuit, an FFT analyzer, and the like. Signal processing by the signal processing device 156 may be partially realized by software, and may also be realized by an ASIC (application specific integrated circuit) and an FPGA (field-programmable gate array).

The display device 155 displays images generated by the signal processing device 156. The display device 155 also displays a GUI image showing information for the user operation. The input device 154 is a device through which users inputs data (including commands) such as a track ball, a keyboard, and a mouse, for example.

The processor 152 controls other components of the control analyzer 105.

For example, the processor 152 controls a driving signal given to the ultrasonic probe 102 through the scanner interface 157. The processor 152 controls the scanner 106 and moves the ultrasonic probe 102 to a desired position through the scanner interface 157.

The processor 152 may be made of a signal processing unit or a plurality of processing units, and may include a signal or a plurality of computer units or a plurality of processing cores. The processor 152 may include one or a plurality of central processing unit(s), a microprocessor, a microcomputer, a microcontroller, a digital signal processor, a state machine, a logic circuit, a graphic processing unit, a chip-on system, and/or a unit that operates signals based on a control command.

The storage device 153 stores therein command codes to be executed by the processor 152, information required for signal processing and control, parameters, and processing results. The storage device 153 may include one or more volatile storage device(s) and/or one or more non-volatile storage device(s). The volatile storage device and the non-volatile storage device may include a non-transient storage medium to store data.

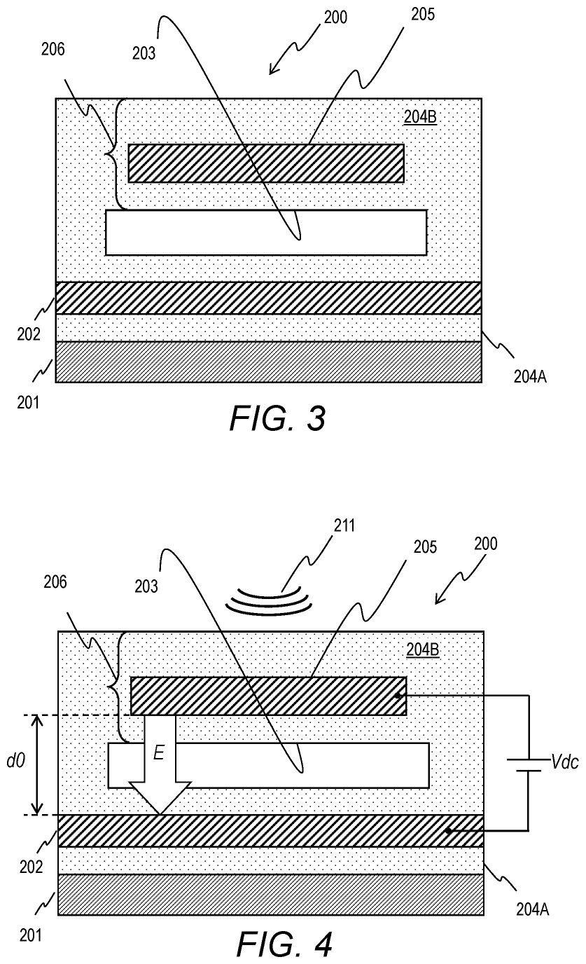

With reference to FIG. 3, the basic structure and operation of a CMUT will be explained. FIG. 3 schematically illustrates a cross-sectional structure of a basic CMUT 200. A substrate 201 has an insulating film 204A formed thereon, and a lower electrode 202 is formed on the insulating film 204A. Above the lower electrode 202, a hollow portion 203 is formed, surrounded by the insulating film 204B. A part of the insulating film 204B above the hollow portion 203 and the upper electrode 205 constitute a membrane 206.

The insulating films 204A and 204B are made of Si_{X}O_{Y} (silicon oxide), Si_{X}N_{Y} (silicon nitride), Si_{X}O_{Y}N_{Z} (Silicon oxynitride), Hf_{X}O_{Y} (Hafnium oxide), Y-doped Hf_{X}O_{Y} (Yttrium-doped hafnium oxide), Si-doped Hf_{X}O_{Y} (silicon-doped hafnium oxide), La_{X}Ta_{Y}O_{Z} (lanthanum oxide+tantalum oxide), and the like. The thickness thereof is in a range of 10 nm to 5000 nm, for example.

The height of the hollow portion 203 is in a range of 10 nm to 5000 nm, for example. The planar shape of the hollow portion 203 may be any shape such as a quadrangle, circle, or polygon. The plane size of the hollow portion 203 varies depending on the frequency band of the membrane 206, but is set such that the length of one side is in the range of about 100 nm to 1,000,000 nm if the planar shape of the hollow portion 203 is a quadrangle, for example,

The lower electrode 202 and the upper electrode 205 may be made of a metal or a semiconductor doped with a high-density impurity, and examples thereof include W, Ti, TiN, Al, Cr, Pt, At, Si, poly-Si, and amorphous Si.

In transmitting ultrasonic waves, the control analyzer 105 superimposes a DC bias voltage with an AC voltage between the upper electrode 205 and the lower electrode 202. This causes an electrostatic force to act between the upper electrode 205 and the lower electrode 202, and causes the membrane 206 to vibrate at the frequency of the applied AC voltage, thereby generating ultrasonic waves. By applying an AC voltage having a frequency close to the resonance frequency of the membrane 206, ultrasonic waves can be more efficiently generated.

In receiving ultrasonic waves, the control analyzer 105 applies a DC bias voltage between the upper electrode 205 and the lower electrode 202. A constant DC voltage of the DC bias voltage is applied to the membrane 206 to generate an electrostatic force, and the membrane 206 vibrates due to the pressure of the ultrasonic waves reaching the surface of the membrane 206. Then, the distance between the upper electrode 205 and the lower electrode 202 changes, and by converting the change in capacitance into a change in voltage, ultrasonic waves can be measured. In this process as well, ultrasonic waves having a frequency close to the resonance frequency of the membrane 206 can be received more efficiently.

FIG. 4 schematically illustrates a CMUT 200 that receives an ultrasonic wave 211. A DC bias voltage Vdc is applied between the upper electrode 205 and the lower electrode 202. Although not illustrated in FIG. 4, the DC bias voltage Vdc generates an electrostatic attractive force between the upper electrode 205 and the lower electrode 202, and the distance between the upper electrode 205 and the lower electrode 202 is determined by the relationship between the repulsive force of the membrane 206 and the electrostatic attractive force.

In the state where the DC bias voltage Vdc is applied, the equivalent distance in vacuum between the upper electrode 205 and the lower electrode 202 is d0, and the electric field strength between the upper electrode 205 and the lower electrode 202 is E. The ultrasonic wave reception sensitivity of the CMUT 200 is proportional to d0/E. That is, in order to increase the reception sensitivity, it is necessary to apply a higher DC bias voltage Vdc.

However, if a high DC bias voltage Vdc is continuously applied to the CMUT 200, the reception sensitivity of the CMUT 200 gradually decreases. This is presumably caused by electrons that have entered the insulating film due to the DC bias voltage Vdc. The electrons in the insulating film weakens the electric field strength between the upper electrode 205 and the lower electrode 202.

When the voltage application to the CMUT 200 is stopped, the reception sensitivity improves. This is presumably caused by the electrons returning from the insulating film to the electrodes. However, if a high DC bias voltage Vdc is continuously applied to the CMUT 200 for a long period of time, the reception sensitivity would remain at a low level. This is presumably caused by the electrons being trapped in the insulating film in energy order.

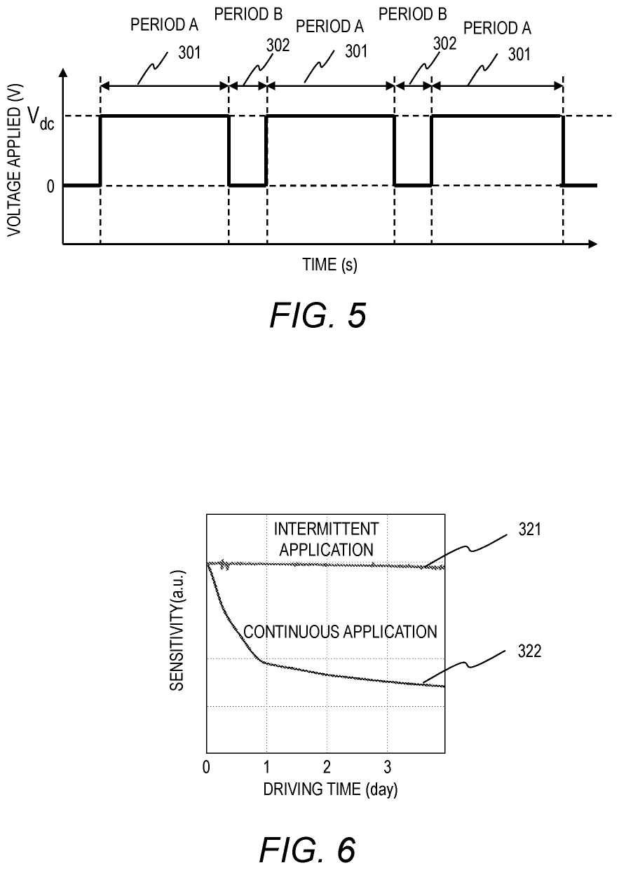

The control analyzer 105 of this embodiment suppresses a decrease in the reception sensitivity of the CMUT 200 by reducing the DC voltage applied to the CMUT 200 at appropriate timings while measuring ultrasonic waves using the ultrasonic probe 102. FIG. 5 illustrates the temporal change of the DC voltage applied to the CMUT 200. The period A301 alternates with the period B302. The driving mode A of the CMUT 200 in the period A301 differs from the driving mode B of the CMUT 200 of the period B302.

In the period A301 (driving mode A), the control analyzer 105 applies the DC bias voltage Vdc to the CMUT 200. The DC bias voltage Vdc is greater than 0V. In the period A301, the control analyzer 105 measures echo from the imaging target 101 using the ultrasonic probe 102, and generates an image of the imaging target 101.

In the example illustrated in FIG. 5, the same DC bias voltage is applied to the CMUT 200 in both transmission and reception. When ultrasonic wave is transmitted, the DC bias voltage is superimposed with an AC voltage. The DC bias voltage may differ between transmission and reception. In the transmissive ultrasonic imaging apparatus, the CMUT 200 only performs transmission in the period A301, and thus is applied with the DC bias voltage only.

In the period B302 (driving mode B), the control analyzer 105 stops the measurement of ultrasonic waves using the ultrasonic probe 102. In the period B302, the control analyzer 105 applies a voltage equal to or greater than 0V but not exceeding the DC bias voltage Vdc to the CMUT 200. In the example of FIG. 5, 0V is applied to the CMUT 200 in the period B302.

The voltage here includes the direction (polarity). Thus, if a voltage greater than 0V is applied, the polarity of the voltage (direction of the voltage or electric field) is the same as the polarity in the period A301. For example, if the potential of the upper electrode 205 is higher than the potential of the lower electrode 202 in the period A301, the potential of the upper electrode 205 is equal to or greater than the potential of the lower electrode 202 in the period B302.

Making a voltage applied to the CMUT 200 in the period B302 lower than the DC bias voltage Vdc in the period A301 allows electrons trapped in the insulating film to escape from the insulating film to the electrodes more easily. As a result, the sensitivity of the CMUT 200 that has decreased during the period A301 can be restored, and this helps to prevent the sensitivity of the CMUT 200 from being constantly low. 0V can achieve the greatest effect.

The voltage applied to the CMUT 200 during the period B302 is 0V or a voltage having the same polarity as the DC bias voltage Vdc in the period A301, and therefore, the power source circuit that applies a voltage to the CMUT 200 may have a simpler configuration as compared to the case where a voltage of the opposite polarity is applied.

In the example illustrated in FIG. 5, the period A301 is longer than the period B302. Thus, the time required to measure ultrasonic waves by the ultrasonic probe 102 and generate an image from the measured ultrasonic wave hardly differs from the case in which the period B302 does not occur.

The period A301 lasts for minutes or hours, but the period B302 lasts for seconds.

In the example illustrated in FIG. 5, the length of the repeated periods A301 is the same as each other, and the length of the periods B302 is also the same as each other. In other examples, part or all of the periods A301 may have different lengths, and part or all of the periods B302 may have different lengths. The maximum value of the period B302 is smaller than the minimum value of the period A301. The maximum value of the period B302 may be greater than the minimum value of the period A301.

In the period B302, the control analyzer 105 short-circuits the upper electrode 205 and the lower electrode 205 to apply 0V, for example. Alternatively, the control analyzer 105 may apply the same constant voltage to the upper electrode 205 and the lower electrode 202 from a constant potential line (such as a grand line and power source line).

In the example of FIG. 5, a bias voltage in the period A301 remains constant, and in the example of FIG. 5, a voltage in the period B302 remains constant. This makes it easier to drive the CMUT 200. In other examples, the bias voltage in the period A301 may be greater than 0V, and may fluctuate as long as it has the same polarity, depending on the imaging position, for example. The voltage in the period B302 may fluctuate as well. In the configuration in which the bias voltage fluctuates during the period A301 and/or the application voltage fluctuates during the period A302, the maximum value of the application voltage during the period B302 is smaller than the minimum value of the bias voltage during the period A301.

In the example of FIG. 5, the period A301 alternates with the period B302. This makes it possible to suppress a decrease in reception sensitivity of CMUT 200 more effectively. In other examples, the period B302 may be inserted after a plurality of periods A301, and the interval of the period B302 that takes place between the two successive periods A301 does not have to be even. As described above, by inserting each of a plurality of periods B302 after each pair of successive periods A301, it is possible to suppress a decrease in reception sensitivity of the CMUT 200 more effectively. The interval of the period B302 may be set to any appropriate number. For example, the period B302 may occur only once over the operation period of the ultrasonic imaging apparatus 10.

In the period B302, the control analyzer 105 may apply a bias voltage higher than 0V, and measure ultrasonic waves using the ultrasonic probe 102. In this configuration, the maximum value of the application voltage during the period B302 is smaller than the minimum value of the application voltage during the period A301.

FIG. 6 is a graph showing a change in reception sensitivity when the voltage applied to the CMUT 200 is reduced intermittently, and a change in reception sensitivity when the DC bias voltage is continuously applied. In the graph of FIG. 6, the line 321 shows a temporal change of the reception sensitivity under the conditions of the DC bias voltage in the period A301 being 60V, the length of the period A301 being 20 minutes, the voltage in the period B302 being 0V, and the length of the period B302 being 10 seconds. The line 322 shows a temporal change of the reception sensitivity when the DC bias voltage of 60V is continuously applied. As shown in FIG. 6, by reducing the voltage applied to the CMUT 200 intermittently, a decrease in reception sensitivity can be suppressed.

### Embodiment 2

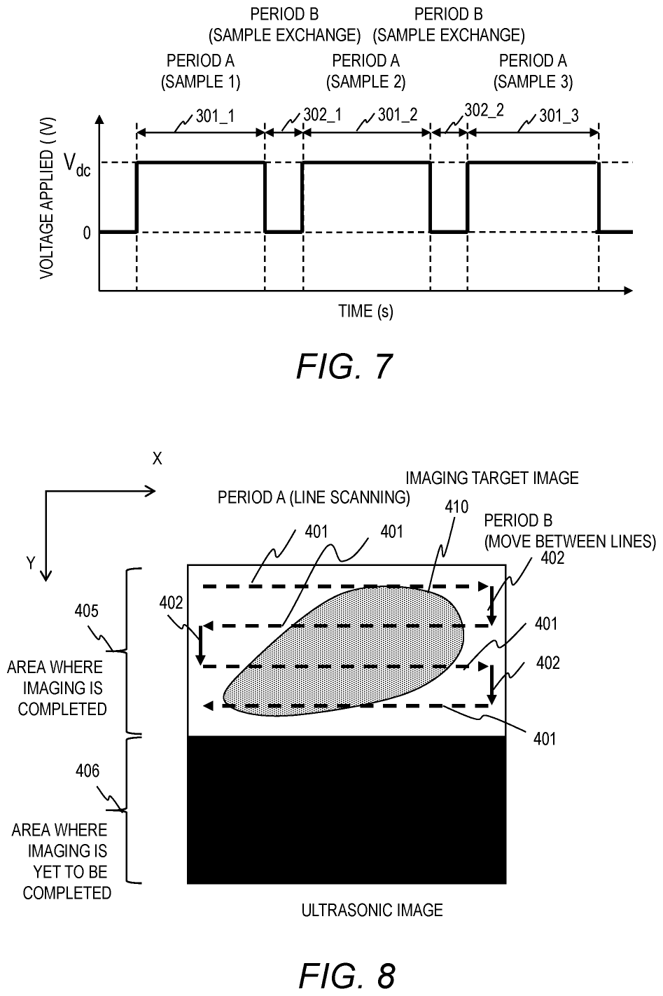

Next, an application example of the period A and the period B will be explained. FIG. 7 shows an example of a temporal change of the DC voltage applied to the CMUT 200, and the period B coincides with the exchange of imaging samples. The imaging samples (objects to be measured) are samples of an industrial product to be tested, for example. As shown in FIG. 7, in the period A301-1, the control analyzer 105 applies the DC bias voltage Vdc to the CMUT 200, measures ultrasonic waves from the sample 1, and generates an image.

In the period B302-1 that follows the period A301-1, the control analyzer 105 applies 0V to the CMUT 200. During the period B302-1, the imaging sample is changed from Sample 1 to Sample 2. In the period A301-2 that follows the period B302-1, the control analyzer 105 applies the DC bias voltage Vdc to the CMUT 200, measures ultrasonic waves from the sample 2, and generates an image.

In the period B302-2 that follows the period A301-2, the control analyzer 105 applies 0V to the CMUT 200. During the period B302-2, the imaging sample is changed from Sample 2 to Sample 3. In the period A301-3 that follows the period B302-2, the control analyzer 105 applies the DC bias voltage Vdc to the CMUT 200, measures ultrasonic waves from the sample 3, and generates an image.

The control analyzer 105 can automatically switch the driving mode of the period A and the driving mode of the period B with each other at the same time as the exchange of imaging samples, and may switch the driving mode of the period A and the driving mode of the period B with each other according to a command from the input device 154.

As described above, by reducing the voltage applied to the CMUT 200 while the imaging samples are being exchanged, it is possible to suppress a decrease in reception sensitivity of the CMUT 200 without affecting the imaging time. Such a configuration of the period A and the period B can be applied to an ultrasonic diagnosis apparatus, for example. The control analyzer 105 applies 0V to the CMUT 200 during a period in which one patient, which is the imaging target, is replaced with another patient, for example.

Next, another application example of the period A and the period B will be explained. In the example described below, the scanning process of the imaging target 101 is synchronized with the period A and the period B. FIG. 8 schematically illustrates a relationship between an ultrasonic image generated by the ultrasonic imaging apparatus 10, and the trajectory of the imaging position (ultrasonic probe 102).

The control analyzer 105 can control the scanner 106 and move the ultrasonic probe 102 along the plane with a high degree of accuracy. The control analyzer 105 moves the ultrasonic probe 102 within the same plane, measures ultrasonic waves at different positions, and processes reception signals from the ultrasonic probe 102, thereby generating a grayscale image.

In the example of FIG. 8, the ultrasonic image includes an area 405 where imaging is completed and an area 406 where imaging is yet to be completed. The area 405 where imaging is completed includes the imaging target image 410.

In the example of FIG. 8, the control analyzer 105 conducts line scanning during the period A401, and moves between scan lines during the period B402. The period A401 alternates with the period B402.

Specifically, in the period A401, the control analyzer 105 moves the ultrasonic probe 102 along the X axis, and measures ultrasonic waves. The control analyzer 105 applies a DC bias voltage for measuring ultrasonic waves during the period A401, and in a reflective ultrasonic imaging apparatus, the control analyzer 105 further applies a superimposed voltage of a DC bias voltage and an AC voltage for transmitting ultrasonic waves. In the example of FIG. 8, the moving directions of the successive periods A401 are opposite to each other.

In the period B402, the control analyzer 105 applies a lower voltage, such as 0V, to the CMUT 200, while moving the ultrasonic probe 102 in one direction along the Y axis. In the period B402, ultrasonic wave measurement is not performed. As described above, by applying a low voltage to the CMUT 200 when the control analyzer moves from one scan line to another scan line, it is possible to suppress a decrease in reception sensitivity of the CMUT 200 without affecting the imaging time.

### Embodiment 3

Next, an example of a driving method for CMUT 200 (ultrasonic probe 102) that depends on the sensitivity test of the CMUT 200 will be explained. In the example described below, the control analyzer 105 performs the sensitivity test on the CMUT 200 (ultrasonic probe 102) after the low-voltage driving in the period B. If the sensitivity is smaller than a prescribed threshold value, the control analyzer 105 applies a low voltage to the CMUT 200 for a prescribed period of time before the start of the measurement in the period A. This makes it possible to maintain a desired sensitivity level of the CMUT 200 (ultrasonic probe 102).

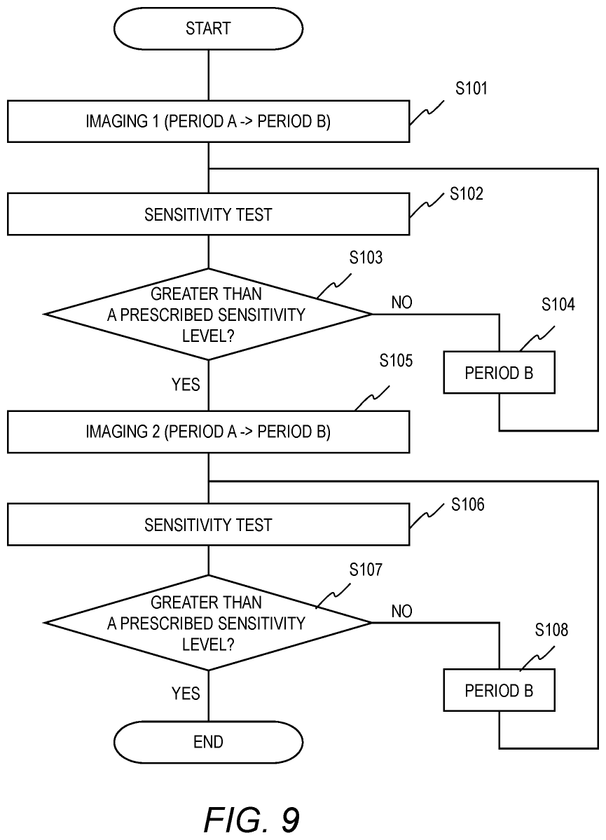

FIG. 9 is a flowchart showing an example of the driving method for CMUT 200 that depends on the sensitivity test result. FIG. 9 illustrates an example where two imaging targets are subjected to imaging. The processor 152 of the control analyzer 105 performs the period A operation on the first imaging target to generates an ultrasonic image of the first imaging target, and then performs the period B operation (S101). After the period B, the processor 152 performs a sensitivity test of the CMUT 200 (ultrasonic probe 102) (S102).

In the sensitivity test in a reflective ultrasonic wave imaging apparatus, ultrasonic waves from a prescribed reflective body are measured by the ultrasonic probe 102, for example. In the sensitivity test in a transmissive ultrasonic wave imaging apparatus, ultrasonic waves from an ultrasonic wave generator that have not passed through an imaging target are measured directly by the ultrasonic probe 102, for example. Alternatively, ultrasonic waves from an ultrasonic wave generator that has passed through a transmissive body may be measured by the ultrasonic probe 102.

The processor 152 compares the sensitivity test result with a prescribed threshold value stored in the storage device 153 in advance (S103). If the test result does not exceed the threshold value (S103: NO), the processor 152 performs the period B driving mode of the CMUT 200 before the start of the measurement of the second imaging target (S104). After the period B, the processor 152 returns to Step S102 and performs the sensitivity test.

If the sensitivity test result exceeds the threshold value (S103: YES), the processor 152 starts an imaging process on the second imaging target. That is, the processor 152 performs the period A operation on the second imaging target to generate an ultrasonic image of the second imaging target, and then performs the period B operation (S105).

After the period B in Step S105, the processor 152 performs the sensitivity test on the CMUT 200 (ultrasonic probe 102) (S106). The processor 152 compares the sensitivity test result with a prescribed threshold value (S107). If the test result does not exceed the threshold value (S107: NO), the processor 152 performs the period B driving mode of the CMUT 200 before the start of the measurement of the next imaging target (S108). After the period B, the processor 152 returns to Step S106 and performs the sensitivity test.

In Steps S104 and S108, the duration of low voltage application may be the same as or differ from the duration of low voltage application in Step S101 and S105. The processor 152 may determine the duration of Step S104 and S108 based on the sensitivity test results, for example. A relationship between the test result and duration is determined in advance. The applied voltage in Steps S104 and S108 may be the same or differ from the applied voltage in the period B of Steps S101 and S105. The processor 152 may determine the applied voltage of Step S104 and S108 based on the sensitivity test results, for example. A relationship between test result and applied voltage is determined in advance.

The determination of Steps S103 and S107 may be conducted by an operator. For example, in Step S103, the processor 152 displays the sensitivity test result in the display device 155, and the processor 152 proceeds to Step S104 or S105 according to a command from the operator.

The same applies to Step S107.

The present invention is not limited to the above-described embodiments but includes various modifications. The above-described embodiments are explained in details for better understanding of the present invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card.

The drawings shows control lines and information lines as considered necessary for explanations but do not show all control lines or information lines in the products. It can be considered that almost of all components are actually interconnected.

What is claimed is:

1. A measurement method of an ultrasonic wave using a capacitive micromachined ultrasonic transducer, comprising:
measuring an ultrasonic wave by applying a bias voltage to the capacitive micromachined ultrasonic transducer in each of a plurality of first periods; and
applying a voltage that is equal to or greater than 0V and smaller than the bias voltage to the capacitive micromachined ultrasonic transducer in a second period that occurs between two first periods among the plurality of first periods.

2. The measurement method according to claim 1, wherein measurement of an ultrasonic wave is paused in the second period, and
wherein a duration of each of the first periods is longer than that of the second period.

3. The measurement method according to claim 1, wherein a voltage applied to the capacitive micromachined ultrasonic transducer is kept at 0V during the second period.

4. The measurement method according to claim 1, wherein a voltage that is equal to or greater than 0V and smaller than the bias voltage is applied to the capacitive micromachined ultrasonic transducer in a plurality of second periods, and
wherein each of the plurality of second periods is inserted between two successive first periods among the plurality of first periods.

5. The measurement method according to claim 4, wherein the first periods alternate with the second periods.

6. The measurement method according to claim 4, wherein a duration of the plurality of first periods is the same as each other, and a duration of the plurality of second periods is the same as each other.

7. The measurement method according to claim 4, wherein a target of measurement is replaced in each of the second periods.

8. The measurement method according to claim 4, wherein a line to be scanned moves from one line to another line in each of the second periods.

9. The measurement method according to claim 1, further comprising:
performing a sensitivity test on the capacitive micromachined ultrasonic transducer after the second period, and
applying a voltage that is equal to or greater than 0V and smaller than the bias voltage to the capacitive micromachined ultrasonic transducer before a start of a first period that follows said second period, if the sensitivity obtained as a result of the test is smaller than a threshold value.

10. A ultrasonic imaging apparatus, comprising:
an ultrasonic probe including a plurality of capacitive micromachined ultrasonic transducers; and
a controller that controls the ultrasonic probe,
wherein the controller is configured to:
measure an ultrasonic wave by applying a bias voltage to the capacitive micromachined ultrasonic transducers in each of a plurality of first periods, and generate an image of a target; and
applying a voltage that is equal to or greater than 0V and smaller than the bias voltage to the capacitive micromachined ultrasonic transducers in a second period that occurs between two first periods among the plurality of first periods.
